(19) United States
(12) Patent Application Publication
(10) Pub. No.: US 2011/0307904 A1
(43) Pub. Date: Dec. 15, 2011

(54) METHOD AND APPARATUS FOR AUTOMATION LANGUAGE EXTENSION

(76) Inventor: James Malnati, Stillwater, MN (US)

(21) Appl. No.: 12/814,517

(22) Filed: Jun. 14, 2010

(51) Int. Cl. G06F 9/54; G06F 9/46

(52) U.S. Cl. 719/313; 719/328; 719/318

(57) ABSTRACT

Systems and methods operable to output a packet of data a management application is unable to directly process to perform a desired operation, communicate the output packet of data to a language service application adapted to perform the desired operation, perform the desired operation using data of the packet of data to provide operation results, and, input the operation results to the management application for processing by the management application using native processing capabilities of the management application are disclosed.

### RELATED APPLICATIONS

The following commonly-assigned patent applications have at least some subject matter in common with the current application:

Serial number [attorney docket number RA5912] entitled “Method and Apparatus for Enhanced Alert Handling”, filed ______; and

Serial number [attorney docket number RA5905] entitled “Method and Apparatus for Automated Alert Documentation”, filed ______, the disclosures of which are hereby incorporated herein by reference.

### TECHNICAL FIELD

The present disclosure relates generally to computer-based automation languages and, more particularly, to extension of computer-based automation languages.

### BACKGROUND OF THE INVENTION

Computer systems (e.g., information technology systems) are essential to many modern businesses. These systems are often complex and continue to grow increasingly more complex. For instance, such systems may include distributed centers located anywhere from a few miles apart to those across the continent or in separate countries. Today, personal computers are common, even nearly ubiquitous, and many businesses employ multiple operating systems from various vendors. Often, systems of a company are dispersed in branch offices running critical applications or containing essential data. These systems include numerous components that need to be managed. Accordingly, it is often very important, and sometimes mission critical, that infrastructure for controlling, monitoring, and managing complex computer systems be provided.

Tools are available that integrate operational control of multiple heterogeneous mainframes and distributed systems. For example, the infrastructure for controlling, monitoring, and managing complex computer systems often comprises a computer system “management application,” which refers generally to software applications that monitor, control, and/or otherwise manage the operation of computer systems. One exemplary type of computer system management application is that referred to as a Single Point Operations software, which supports centralized control and automated operations of multiple data processing systems. Typically, managed objects are used to view, monitor, and manage the various computer system components. The managed objects are typically predefined in operational software (e.g., in a management application) for managing the components of the system. For instance, such systems may employ filters that compare managed objects to a property threshold, whereby an alert is raised on a managed object when a property of the object satisfies the threshold.

Many computer system management applications allow users to define rules and corresponding actions that the application is to automatically trigger upon the conditions that it monitors satisfying the defined rules. For instance, a user may use an automation language of a management application to define one or more message-matching rules that specify certain messages that the management application receives/detects (e.g., system messages generated by one or more monitored computer systems), and the rules may further specify one or more actions that are to be triggered by the management application upon such a message match.

As an example, Single Point Autoaction Message System™ (SP-AMS™) software is an automation language contained in Operations Sentinel® by Unisys® Corporation. SP-AMS is a utility that allows a user to specify messages to match and actions to automatically perform (e.g., without operator interaction) when a message is received and matched. ClearPath Plus OS 2200 Autoaction Message System™ (CP-AMS™) is also part of Operations Sentinel. SP-AMS automates system operations for MCP and UNIX/Linux systems and partitions; and CP-AMS automates system operations for OS 2200 partitions in a ClearPath Plus server.

Operations Sentinel uses a CP-AMS autoaction database associated with each OS 2200 console and an SP-AMS autoaction database associated with managed UNIX, MCP, and Linux partitions, to identify system messages and automatically execute actions. These actions can include raising alerts that are displayed in the Alerts window of Operations Sentinel Console. In addition to displaying alerts, a user may create rules to activate external paging devices (or other communication/notification devices, such as mobile telephones, etc.) when an alert is raised, acknowledged, or cleared. Actions may also include cross-system commands sent to another managed system.

A primary function of SP-AMS is to parse console messages and respond to problems by taking command actions, raising alerts, and logging exceptions. These actions are specified within an easy to use automation language.

The design of the automation language of such management applications, however, may purposely be simplified to facilitate use by personnel having less technical training, no limited training in automation languages, etc. Accordingly, there is often a lack of traditional programming constructs, such as “while/do,” “for/each,” and “switch/case” statements, in the automation language of the management applications. Therefore, improvements are desirable.

### BRIEF SUMMARY OF THE INVENTION

A method according to an embodiment herein comprises outputting, by a management application, a packet of data the management application is unable to directly process to perform a desired operation and communicating the output packet of data to a language service application adapted to perform the desired operation. The method of this embodiment further comprises performing, by the language service application, the desired operation using data of the packet of data to provide operation results and inputting the operation results to the management application for processing by the management application using native processing capabilities of the management application.

A system according to an embodiment herein comprises a management application having an automation language unable to directly perform at least one desired programming construct, the management application operable to accept input of reporting messages, to provide processing of the reporting messages, and to output reporting messages. The system of this embodiment further comprises a language service application operable to perform at least one desired programming construct and to provide output from the performance of at least one desired programming construct. This system of this embodiment also comprises an Application Programming Interface (API) operable to provide data communication between the management application and the language service application, to accept output of a reporting message from the management application and provide data of the reporting message to the language service application for the performance of at least one desired programming construct, and to accept the output from the performance of at least one desired programming construct and provide data of the performance of at least one desired programming construct to the management application as a reporting message.

A computer program product for providing management application automation language extension according to an embodiment herein comprises Application Programming Interface (API) code for communicating a packet of data the management application is unable to directly process to perform a desired operation to a language service application adapted to perform the desired operation. The computer program product of this embodiment further comprises language service application code for performing the desired operation using data of the packet of data to provide operation results. The computer program product of this embodiment also comprises API code for inputting the operation results to the management application for processing by the management application using native processing capabilities of the management application.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 shows a block diagram of a computer system for which management application automation language extension may be provided in accordance with embodiments herein;

FIG. 2 shows a block diagram illustrating one exemplary embodiment of a management application automation language extension system; and

FIG. 3 shows a flow diagram illustrating operation in accordance with embodiments herein.

### DETAILED DESCRIPTION OF THE INVENTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

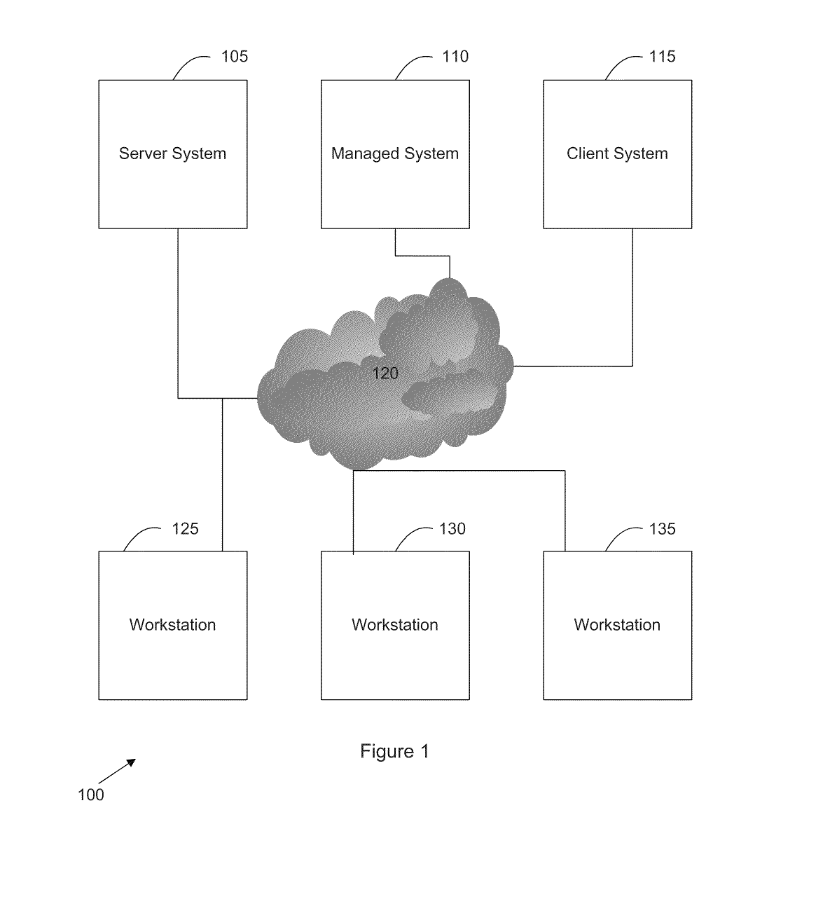

FIG. 1 shows a block diagram of a computer system (system 100) for which management application automation language extension may be provided in accordance with embodiments herein. The illustrated embodiment of system 100 comprises a large distributed computing system. System 100 includes server system 105, managed system 110, computer workstations 125, 130, and 135, and client system 115, as are well known in the art. Each of server system 105, managed system 110, computer workstations 125, 130, and 135, and client system 115 preferably comprise a processor (e.g., central processing unit (CPU)), memory, and input/output interfaces appropriate to their uses, wherein the processor operates under control on one or more instruction sets (e.g., operating system (OS), application software, etc.) to provide desired operation, as is well known in the art. Server system 105, managed system 110, computer workstations 125, 130, and 135, and client system 115 preferably communicate with one another over a network (network 120), which may comprise any suitable network such as a local area network (LAN), metropolitan area network (MAN), wide area network (WAN), the Internet, an extranet, the public switched telephone network (PSTN), a cellular network, and/or the like.

In one exemplary embodiment, server system 105 acts as a maintenance processing system and/or a utility monitoring processing system that functions to monitor the activities and health of the components, processes, and tasks executing within the managed system 110. Managed system 110 performs the processing desired by the operators of managed system 110. Client system 115 includes processing systems utilized by operators of managed system 110 to view operations, maintenance and health information regarding the components, processes and tasks in managed system 110. Furthermore, any one or more of computer workstations 125, 130, and 135 may include processing systems utilized by operators of managed system 110 to view operations, maintenance and health information regarding the components, processes and tasks in managed system 110. In some embodiments, client system 115 may, itself, be a computer workstation that is a peer of workstations 125, 130, and 135. In the embodiment shown in FIG. 1, these systems are shown to be separate processing systems. However, one of ordinary skill in the art will recognize that these systems may be implemented to operate on one as well as numerous hardware systems without deviating from the spirit and scope of the present invention as recited within the attached claims.

A computer system management application is operable upon one or more systems (e.g., server system 105, managed system 110, and/or client system 115) of system 100 to provide an operational environment for managing system 100. In one example embodiment, Operations Sentinel® by Unisys® provides such an operational environment for managing computing system 100. Operations Sentinel® includes a Graphical User Interface (GUI) for managing alerts in a computing system. Accordingly, Operations Sentinel® may be utilized to provide visual and/or audible alerts at server system 105. Additionally or alternatively, one or more of server system 105, client system 115, and computer workstations 125, 130, and 135 includes a utility for generating visual and/or audible alerts of system conditions. It may also be the case that some alerts are directed to certain ones of the workstations and not to others. In addition, a GUI is provided in some embodiments so that commands may be sent to portions of the system generating the alert without the overhead of starting the Operations Sentinel® GUI at server system 105 or the actual system console. Use of commands may be restricted on some ones of workstations 125, 130, and 135 according to established user permission. While reference is made to Operations Sentinel®, it is understood that various embodiments are applicable to any suitable management application for a distributed computing system.

Computer system management applications, such as the aforementioned Operations Sentinel® implementing the Single Point Autoaction Message System™ (SP-AMS™) available from Unisys Corporation, provide a convenient way to control, monitor, and manage complex computer systems. Such a management application may, for example, be utilized to parse console messages (e.g., including error conditions, status reports, alarm conditions, etc.) and initiate appropriate responses (e.g., respond to problems by taking command actions, raising alerts, logging exceptions, etc.). The design of the automation language of such management applications may purposely be simplified to facilitate use by personnel having less technical training, no limited training in automation languages, etc. For example, such management applications are often heavily utilized by data center operators with little training with respect to computer-based languages.

More sophisticated users (e.g., “power users”) and those with advanced programming knowledge are often frustrated by the lack of traditional programming constructs in the automation languages of management applications. For example, “while/do,” “for/each,” and “switch/case” statements are often not available in the automation languages of management applications due to the design constraints under which such automation languages are developed (e.g., the aforementioned simplified design).

Accordingly, embodiments herein provide a management application automation language extension which facilitates implementation of more complex, advanced programming constructs (e.g., while/do, for/each, switch/case, etc.) while continuing to provide an underlying management application automation language having a simplified design. For example, a language service (e.g., as may be written in C# or another appropriate programming language) is provided that implements the otherwise desired but missing functionality. The language service of embodiments is referred to herein as “Shared Object Manager Application” (SOMA).

In accordance with embodiments of the invention, a two-way interface to a language service that implements advanced programming constructs is provided for use with a management application, because the automation language of the management application has no capacity to implement advanced programming constructs itself. Thus, the aforementioned two-way interface provides a data conduit to/from this language service program. The two-way interface of embodiments comprises a language service Application Programming Interface (API) (e.g., SOMA API) operable to provide data communication between a management application and an associated language service for operation as described herein.

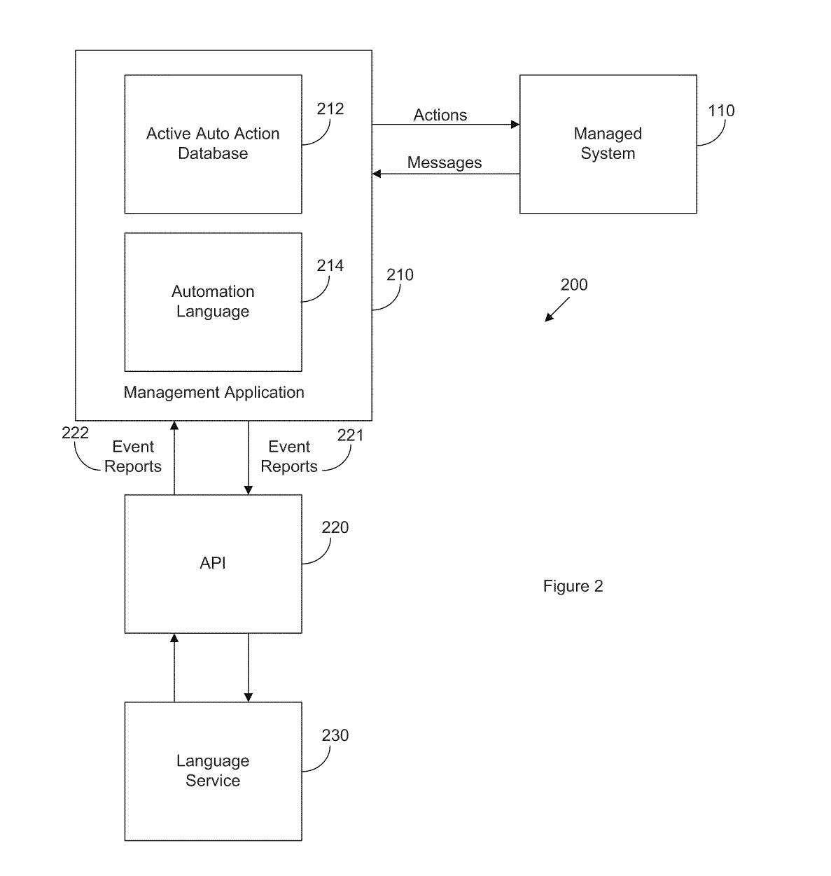

FIG. 2 shows a block diagram illustrating one exemplary embodiment of a management application automation language extension system. Specifically, management application automation language extension system 200, as may be operable upon one or more systems (e.g., server system 105, managed system 110, and/or client system 115) of system 100, is shown in communication with managed system 110 for providing computer system management including implementation of more complex, advanced programming constructs (e.g., while/do, for/each, switch/case, etc.) while continuing to provide an underlying management application automation language having a simplified design.

The embodiment of management application automation language extension system 200 illustrated in FIG. 2 includes management application 201 in communication with language service 230 through API 220, as discussed above. Management application 201 includes automation language 211 which is utilized by users to define rules and corresponding actions that the application is to automatically trigger upon the conditions that it monitors satisfying the defined rules. Management application 201 further includes active autoaction database 202 which may include the user-defined rules that responsive to receive messages from the managed system 201 triggers corresponding autoactions (e.g., autonomous actions that are triggered without requiring user interaction). Exemplary autoaction databases include the aforementioned SP-AMS and CP-AMS autoaction databases, and exemplary actions that may be triggered include those described further herein for the SP-AMS and CP-AMS autoaction databases.

Automation language 211 of embodiments is simplified to facilitate use by personnel having less technical training, no limited training in automation languages, etc. and thus lacks traditional programming constructs (e.g., while/do, for/each, and switch/case statements). Accordingly, language service 230 (e.g., an application written in C# or another appropriate programming language) is provided to provide automation language extension which facilitates implementation of more complex, advanced programming constructs.

In operation according to embodiments, management application 210 supplies a packet of data it is unable to directly process to associated language service 230 (e.g., SOMA) through an appropriate language service API, shown here as API 220. Management application 210 of embodiments also supplies the operation(s) and operator(s) intended for the aforementioned data to language service 230 through the language service API for application to the data. Although the aforementioned data, operation(s), and operator(s) may be passed between the management application and associated language service within a same data packet according to embodiments herein, multiple data packets and multiple sequential operations are also supported.

Language service 230 of embodiments receiving the aforementioned data packet(s) operates to process the data and return the results to associated management application 210, thus providing an automation language extension implementing advanced programming constructs transparently from within the management application. Language service 230 may utilize the aforementioned language service API (API 220) to return results and/or other data to a management application.

API 220 providing for communication to/from language service applications of embodiments is adapted to interface with a management application using input and/or output interfaces native to the management application. Such embodiments minimize adaptation of the management application to accommodate the language service as well as facilitate maintaining an underlying management application automation language having a simplified design. For example, management application 210 may have reporting input/output which may be utilized by API 220 for data communication between management application 210 and language service 230 according to embodiments herein. Thus, one or more “report” output (e.g., Event Report 221) forming data packets containing the aforementioned data, operation(s), and/or operator(s) may be provided to API 220 by management application 210. Similarly, one or more “report” input (e.g., Event Report 222) containing the aforementioned advanced programming construct operation results from language service 230 may be provided to management application 210 by API 220. In accordance with embodiments herein, such a report input presents information to the management application as if it was a standard report (e.g., a standard console message), and thus normal processing capabilities of the management application (e.g., normal console message parsing) may be used to take actions on the information processed by the language service.

To aid in understanding the application of the foregoing concepts of the invention, operation in accordance with embodiments with respect to various example variable constructs are provided below. Specifically, variable groups and their members are discussed. It should be appreciated that this more open-ended form of variable is the most difficult to process and represents the area where a computer-based automation language may be most limited in its capabilities, and thus is an area in which embodiments herein may provide a significant impact.

Using a language service in association with a management application as set forth above, embodiments allow the management application using the language service to perform actions on variable group member contents while a condition exists. For example, it may be desired to process a set of variable group members while a certain condition is true or false. When conditions warrant, the processing should not occur. For instance, this could be a need to increment all integer contents of many variable group members and avoid the increment operation when a specified value occurs in a given member's contents. While such processing may be performed by a typical “while/do” loop, this processing is not possible with many automation languages native to management applications. However, by passing the data, the conditions under which actions should be taken, and the actions themselves to a language service of embodiments, the language service is able to perform the desired tasks and pass the results back to the management application.

Further, using a language service in association with a management application as set forth above, embodiments allow the management application to identify variable group member contents. Although a management application may be operable to determine the existence of a particular variable group member name, such a management application generally cannot process a list of variable group members, examine the contents of each, and identify a member name whose contents meet specific criteria. However, by passing the member names and contents to a language service of embodiments and instructing the language service to parse the values with a “for/each” loop, the language service is able to perform the desired task (e.g., return only those member names whose contents equal a certain value to the management application). Once the management application has the member names in question it may perform the actions required on this subset.

Also using a language service in association with a management application as set forth above, embodiments allow the management application to process all variable group members with different actions based on a condition. This functionality is most easily described as a classic “switch/case” statement, as may be represented by the following pseudo code (a simplified C# switch/case statement).

```
switch (string condition)
{
case “string-comparison-1”
  action-1
case “string-comparison-2”
  action-2
default
  default-action
}
```

By passing all variable group members to the language service the “switch/case” statement may be applied to each variable group member with the actions being passed back to the management application for processing.

The variable groups and their members of the foregoing examples are preferably passed between the management application and the language service using the aforementioned language service APIs. The management application may, for example, provide output of Attribute Change Event Reports (AC) and accept input of Message Event Reports (ME). A language service API may thus accept an AC (e.g., including the variable groups and their members, etc.) from the management application and provide the AC to the language service for performing any of the above exemplary extension processes, for example. Similarly, a language service API may accept a ME (e.g., including the extension processing results) from the language service and provide the ME to the management application for processing. This forms the infrastructure for two-way communication between a management application and an associated language service according to embodiments.

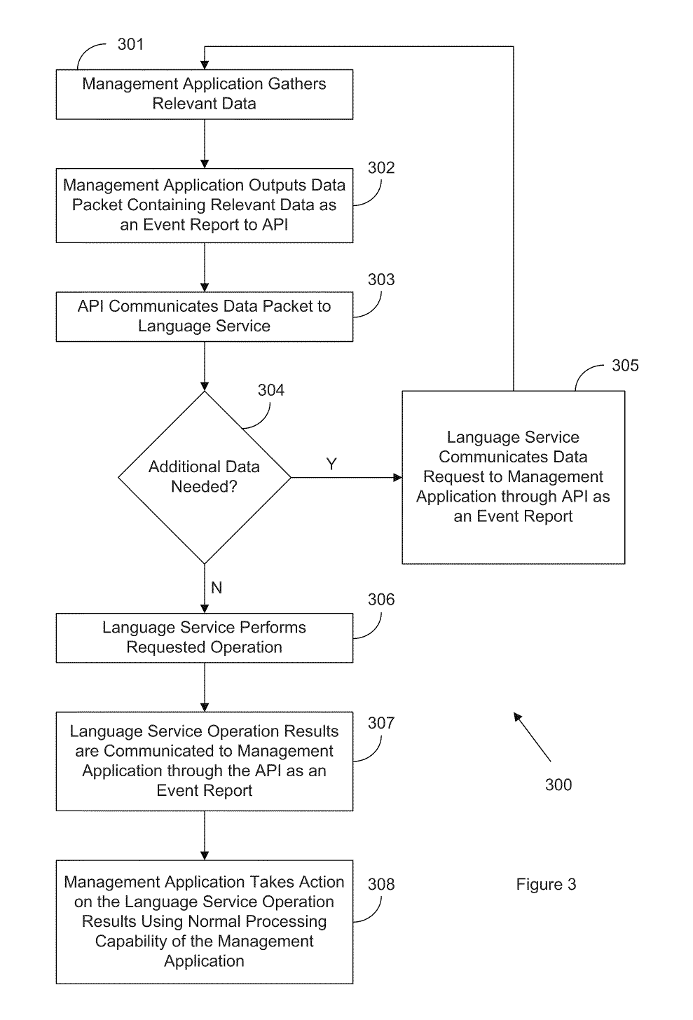

Directing attention to FIG. 3, flow diagram 300 illustrating operation in accordance with embodiments herein is shown. A management application is often utilized to provide a message (e.g., console message) parsing and filtering component of a solution. Thus, a management application may begin a conversation with an associated language service, such as in response to receipt of particular messages, based upon a particular result from processing messages, etc., when sophisticated programming is needed to craft an automation solution. For example, the management application may gather the relevant data (e.g., in the form of variable group members) it is unable to directly process to perform a desired operation, as shown in block 301 and send the data to an associated language service. According to embodiments, the data is provided in an AC Event Report to a language service API as shown in block 302 for communication to the language service. The language service API thus communicates the data to the language service in block 303.

The foregoing process may be carried out using the data portion of a data packet. The operation/operand portion of a data packet may be specified in the INSTANCE field according to embodiments. For example, data packets may be sent in the following format with one or more AC Event Reports:

### TYPE=AC|CLASS=SOMA|INSTANCE=WHILE (CONTENTS<6)|

MEMBERNAMES=\VariableGroup:_ALL\

The complex, advanced programming constructs of a language service of embodiments utilize data in addition to the initially provided by, and perhaps initially available to, the management application. Accordingly, embodiments implement further conversation (e.g., program-to-program conversation) to communicate additional data (e.g., the contents of each variable after initial communication of the variable group member names) utilized in performing extension language processing by the language service. Thus, in the illustrated embodiment the language service determines if additional data is needed to perform the desired operation at block 304. If additional data is needed, the language service communicates a data request to the management application through the API (e.g., in the form of an Event Report) at block 305.

As an example of the foregoing operation, a “while/do” loop typically needs to act on the contents of all variable group members, and a management application may only be able to supply the member names initially. Accordingly, a language service of embodiments will take each member name and request its contents from the management application through multiple requests. For example, the data requests may be provided an a plurality of ME Event Reports to a language service API for communication to the management application. These data packets may be sent in the following format with one or more ME Event Reports:

### TYPE=ME|CLASS=SOMA|INSTANCE=SOMA|APPL=SOMA|TEXT=CONTENTS OF VariableGroup:Member1

### TYPE=ME|CLASS=SOMA IINSTANCE=SOMA|APPL=SOMA|TEXT=CONTENTS OF VariableGroup:Member2

### TYPE=ME|CLASS=SOMA|INSTANCE=SOMA|APPL=SOMA|TEXT=CONTENTS OF VariableGroup:Member3

The management application of embodiments receives these requests for data (e.g., the contents of each variable group member) and responds by outputting the data through separate AC Event Reports. These AC Event Reports are again passed by the language service API to the language service. These response data packets may be sent in the following format with one or more AC Event Reports:

### TYPE=AC|CLASS=SOMA|INSTANCE=CONTENTS|

VariableGroup:Member1=\VariableGroup:Member1\

### TYPE=AC|CLASS=SOMA|INSTANCE=CONTENTS|

VariableGroup:Member2=\VariableGroup:Member2\

### TYPE=AC|CLASS=SOMA|INSTANCE=CONTENTS|

VariableGroup:Member3=\VariableGroup:Member3\

Once any necessary data (e.g., the variable group member contents) has been received by the language service, as determined at block 304, and assigned to the correct language service data structure, the requested language extension operation is performed (e.g., just as it would within C#) at block 306. The results are passed back from the language service to the management application using the language service API at block 307. For example, data packets may be provided to the management application in the ME Event Report format shown above. Such a report input presents information to the management application as if it was a standard report (e.g., a standard console message), and thus normal, native processing capabilities of the management application (e.g., normal console message parsing) are used to take actions on the information processed by the language service at block 308.

From the above, it can be appreciated that without the language extension of a language service of embodiments herein a typical automation language of a management system would be unable to support complex, advanced programming constructs. Thus, tasks such as those of the foregoing examples would not be possible using such a management application without the benefit of language extension as taught herein. Embodiments provide an open interface to a powerful programming language (e.g., C#) which may be utilized to greatly extend the capabilities of a management application automation language.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method comprising:
outputting, by a management application, a packet of data the management application is unable to directly process to perform a desired operation;
communicating the output packet of data to a language service application adapted to perform the desired operation;
performing, by the language service application, the desired operation using data of the packet of data to provide operation results; and
inputting the operation results to the management application for processing by the management application using native processing capabilities of the management application.

2. The method of claim 1, wherein the desired operation of the management application is unable to directly process comprises a programming construct not supported by an automation language of the management application.

3. The method of claim 2, wherein the programming construct is selected from the group of programming statement constructs consisting of while/do, for/each, and switch/case.

4. The method of claim 1, wherein the operation results are input to the management application in a standard report format.

5. The method of claim 4, wherein the standard report format comprises a standard console message format.

6. The method of claim 4, wherein the operation results are input to the management application as an event report.

7. The method of claim 6, wherein the packet of data is output by the management application as an event report.

8. The method of claim 1, wherein the output data packet is communicated from the management application to the language service application via an Application Programming Interface (API).

9. The method of claim 8, wherein the operation results are input to the management application by the API.

10. A system comprising:
a management application having an automation language unable to directly perform at least one desired programming construct, the management application operable to accept input of reporting messages, to provide processing of the reporting messages, and to output reporting messages;
a language service application operable to perform at least one desired programming construct and to provide output from the performance of at least one desired programming construct; and
an Application Programming Interface (API) operable to provide data communication between the management application and the language service application, to accept output of a reporting message from the management application and provide data of the reporting message to the language service application for the performance of at least one desired programming construct, and to accept the output from the performance of at least one desired programming construct and provide data of the performance of at least one desired programming construct to the management application as a reporting message.

11. The system of claim 10, wherein the management application is further operable to process the data of the performance of at least one desired programming construct using native processing capabilities of the management application.

12. The system of claim 10, wherein at least one programming construct is selected from the group of programming statement constructs consisting of while/do, for/each, and switch/case.

13. The system of claim 10, wherein the data of the performance of at least one desired programming construct is provided to the management application by the API in a standard console message format.

14. The system of claim 10, wherein the reporting message comprising the data of the performance of at least one desired programming construct is an event report.

15. The method of claim 14, wherein the reporting message output by the management application is an event report.

16. A computer program product having a computer readable medium having computer program logic recorded thereon for providing management application automation language extension, the computer program product comprising:
Application Programming Interface (API) code for communicating a packet of data the management application is unable to directly process to perform a desired operation to a language service application adapted to perform the desired operation;
language service application code for performing the desired operation using data of the packet of data to provide operation results; and
API code for inputting the operation results to the management application for processing by the management application using native processing capabilities of the management application.

17. The computer program product of claim 16, wherein the desired operation the management application is unable to directly process comprises a programming construct not supported by an automation language of the management application.

18. The computer program product of claim 17, wherein the programming construct is selected from the group of programming statement constructs consisting of while/do, for/each, and switch/case.

19. The computer program product of claim 16, wherein the operation results are input to the management application in a standard report format.

20. The computer program product of claim 19, wherein the standard report format comprises a standard console message format.

21. The computer program product of claim 19, wherein the operation results are input to the management application as an event report.

22. The computer program product of claim 21, wherein the packet of data is output by the management application as an event report.
